(19) United States
(12) Patent Application Publication
(10) Pub. No.: US 2008/0099156 A1
(43) Pub. Date: May 1, 2008

(54) Rapid Folding Door

(76) Inventor: Bernard Kraeutler, Dunieres (FR)

Correspondence Address: CANTOR COLBURN, LLP, 20 Church Street, 22nd Floor, Hartford, CT, 06103, US

(21) Appl. No.: 11/547,380

(22) PCT Filed: Mar. 31, 2005
(86) PCT No.: PCT/FR05/00788

§ 371 Date: Sep. 4, 2007

(30) Foreign Application Priority Data
Mar. 31, 2004 (FR) 0403367

(51) Int. Cl. E06B 9/02; E06B 5/00

(52) U.S. Cl. 160/84.01; 160/213

(57) ABSTRACT

The invention relates to a rapid folding door. The inventive door comprises: two vertical jambs (2), each of which contains a slide; a winding shaft which is disposed at the top of the two vertical jambs (2); and a flexible screen (6) which is equipped with (i) a lower bar (10) which is in turn connected to the winding shaft by means of at least one strap (11) and (ii) at least one reinforcing bar. According to the invention, the width of the screen (6) is smaller than the distance separating the inner faces (2a) of each of the jambs (2). Moreover, the ends of at least one reinforcing bar (9) are fitted and guided in the slides provided in each of the jambs (2). The screen (6) can occupy: a closed position in which it is deployed in a separation plane that is defined by the jambs (2) and the winding shaft, or an open position in which it is folded by winding each strap (11) on the shaft and forming at least one fold on one side of the separation plane. Furthermore, on the side of the screen (6) opposite that comprising the folds, at least one of the jambs (2) is equipped with an elastic sealing means against which the screen (6) rests.

The present invention relates to a rapid folding door.

In order to close off a bay made in an external wall of a building, a door with a flexible shutter may be used in which the shutter folds along the lintel of the bay.

Conventionally, such a door has two jambs connected at the top by a transom and a shutter reinforced by transverse bars inserted laterally in each of the jambs.

The shutter is folded using straps, generally two straps, one end of which is connected to a bar positioned at the bottom of the shutter and the other end of which is fixed to a shaft mounted in the transom of the door. A motor controls the rotation of the shaft on which the straps are wound, thus folding the door under the transom.

The preferred application for this kind of door is its use to separate off a bay providing access to the outside of the building, as these doors have an excellent resistance to the wind. Specifically, the shutter can be equipped with reinforcing bars of large diameter, since these bars do not have to be wound on the shaft as is the case with winding doors.

However, there is an aspect from which these doors are not entirely satisfactory. The jambs, in which the lateral edges of the shutter are engaged, are generally made of C-shaped profiles having two flanges between which the folds of the shutter are stored. Since the shutter, in the raised position, forms folds which take up a considerable volume, the distance separating two flanges must be great and is usually between 300 and 600 mm. Hence, the resulting footprint of the jambs may make them unsuitable for certain places where surface area is limited.

Moreover, there may be problems with sealing between the vertical edges of the shutter and the jambs.

It is an aim of the invention to propose a folding door using jambs with a small footprint which offer good sealing between the shutter and the jambs.

In a manner known per se, this folding door comprises:
two vertical jambs, each of which contains a slide;
a winding shaft positioned at the top of the two vertical jambs;
a flexible shutter with a lower bar connected to the winding shaft by means of at least one strap and at least one reinforcing bar.

According to the invention, the width of the shutter is smaller than the distance separating the inner faces of each of the jambs, in that the ends of at least one reinforcing bar are fitted and guided in the slides provided in each of the jambs, it being possible for the shutter to assume a closed position in which it is deployed in a separation plane defined by the jambs and the winding shaft, or an open position in which the shutter is folded by winding each strap on the shaft and forming at least one fold on one side of the separation plane, and in that, on the side of the shutter opposite that on which the folds are formed, at least one of the jambs comprises an elastic sealing means against which the shutter rests.

The basic idea behind the invention is to form folds not inside the jamb as in conventional doors, but outside them so as to be able to use compact jambs whose slide is dimensioned to receive only the end of a reinforcing bar. This is made possible by the fact that the width of the shutter is smaller than the distance delimited by the inner faces of the jambs, i.e. the faces of the jambs delimiting the width of the passage for the door.

However, it will be noted that there is still a gap between each jamb and the lateral edges of the shutter. The existence of these gaps means that the lateral sealing of such a door is very approximate, with the result that there is an overall lack of thermal and acoustic sealing of the door and dust can enter the space the door is supposed to close off.

For this reason, provision is made that on the side of the shutter opposite that on which the folds are formed, at least one of the jambs comprises an elastic sealing means against which the shutter rests.

The door thus defined combines the advantages of compact jambs and sealing. The elastic sealing means does not interfere with the folding of the door but ensures excellent sealing when the door is deployed.

The elasticity of the sealing means is absolutely essential since the shutter has a bulge at each reinforcing bar. The sealing means therefore has to adapt to such a bulge without which sealing is not actually ensured.

In practice, one of the jambs has two flanges forming slides, the sealing profile being attached to the flange located on the side opposite that on which the folds are formed.

According to one embodiment of the profile, the sealing profiles have a rigid base designed to be pressed against the jamb and a flexible lip designed to rest against the shutter.

Preferably, the flexible lip has a cross section of spiral shape. This arrangement proves extremely favorable to sealing since the spiral lip can be compressed when it is in contact with a bulge formed by a stiffening bar while remaining in contact with the surface of the shutter between two stiffening bars.

According to another aspect of the profile, the base has two substantially perpendicular plates bearing on two faces of a flange of a jamb.

Moreover, each reinforcing bar has, at each of its ends, a roller traveling between the two flanges of the slide.

According to one embodiment of the sealing means, at least one of the jambs has two flanges, the flange located on the side opposite that on which the folds are formed has an extension so as to form a bearing surface for the shutter.

Moreover, the extension may be made by co-extrusion, co-molding or co-pultrusion of an elastic material.

According to another possibility, the extension has an elastically deformable geometry.

According to the configuration of the space in which the door is to be fitted, the jambs containing the slides are vertical or the jambs containing the slides are oriented in a direction other than the vertical.

For a clearer understanding of the invention, the latter is described with reference to the attached drawing which shows, by way of non-limiting example, an embodiment of a door according to the invention.

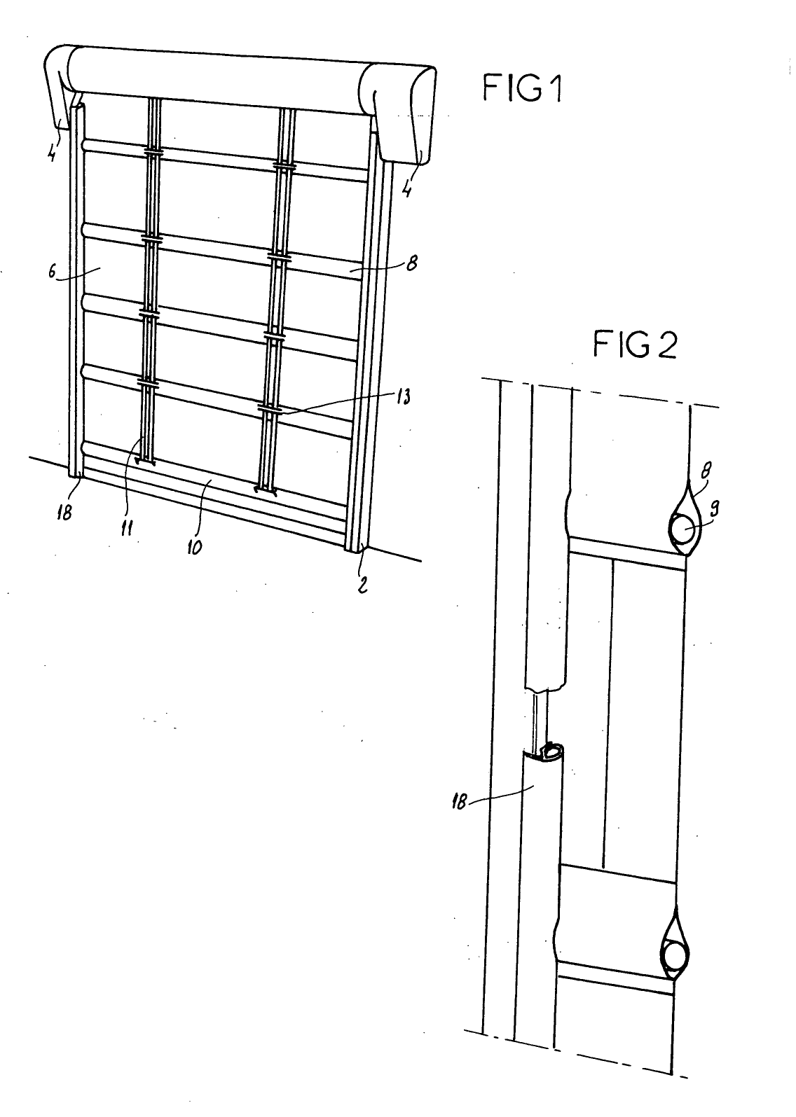

FIG. 1 is a perspective view of the folding door according to the invention.

FIG. 2 is a view of the door at one of its jambs with an area showing a section through a sealing profile and a flexible shutter.

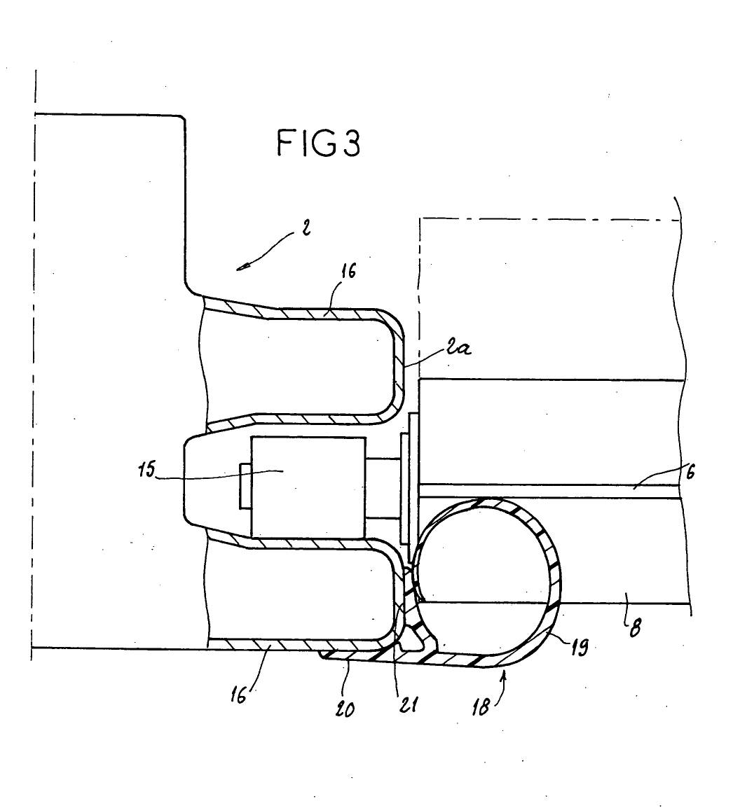

FIG. 3 is a cross-sectional view along III-III of FIG. 1.

A folding door, according to the invention, is shown in FIG. 1 in a configuration in which this door is closed. The door designed to close off a bay made in an outer or partition wall has two vertical jambs 2. The upper end of these jambs is connected by a transverse casing which protects a shaft. This shaft may be rotated by an electric motor. The electric motor is protected by side covers 4.

The plane defined by the inner faces 2a of the jambs 2 and the transverse casing 3 is closed off by a flexible shutter 6. The width of this shutter is slightly smaller than the distance delimited by the inner faces 2a of the jambs 2. This flexible shutter 6 consists of several horizontal strips with gussets 8 at their joins.

As can be seen in FIG. 2, tubular reinforcing bars 9 are inserted in these gussets 8. The particular feature of “folding” doors is that they have straps 11 oriented parallel to the jambs 2, these straps 11 being joined on the one hand to the winding shaft, and on the other hand to a lower bar 10.

As can be seen in FIG. 1, at the intersection between the straps and each transverse bar 9, the shutter 8 has a guide strap 13 through which the strap 11 passes.

Thus, when the winding shaft is rotated, the straps 11 wind up on it, thus raising the lower bar 9.

As it moves upward toward the winding shaft, the lower bar 10 successively meets each of the reinforcing bars 9 positioned above it and thus raises the whole shutter 6. When the winding shaft has finished rotating, said shutter is folded in the upper part of the door, directly below the transverse casing 3.

In its folded position, the shutter forms folds whose formation may be aided by shape-memory folders or by free bars alternating with the reinforcing bars 9.

With reference to FIG. 3, it can be seen that each of the reinforcing bars 9 has, at its end, a roller 15 inserted in a slide 17 delimited by two flanges 16 formed on the jambs 2. These rollers 15 take up the loads to which the shutter and reinforcing bars 9 are subjected.

It will therefore be noted that, since folds (shown in chain line in FIG. 3) are formed in the shutter 6 in order to raise said shutter, there is a problem in terms of sealing since the folds are formed on the outside of the slide delimited by the two flanges 16 of the jamb.

In other words, there is a gap between the lateral edge of the shutter 6 and the jamb 2 facing it. This gap severely hampers the satisfactory operation of these doors since the lateral sealing of such a door is very poor.

For this reason, the door is equipped, as can be seen in the various figures of the drawing, with a sealing profile 18 mounted on the flange 16 of each of the jambs that is located on the side of the shutter opposite that on which the folds are formed. As can be seen in FIG. 3, this sealing profile 18 has two parts: on the one hand, a base part bearing on the flange of the jamb and, on the other hand, a lip 19 which rests on the surface of the shutter.

The base has two substantially perpendicular plates 20, 21, which are very thick so as to ensure good rigidity.

The lip 19 has a cross section of spiral shape. This spiral shape is absolutely essential to ensure good sealing by the profile 18. Specifically, thanks to this spiral shape, the profile 18 can, on the one hand, seal the surface of the shutter 6 and, on the other hand, be compressed when it is at the intersection of the bulge formed by a reinforcing bar 9. This can be clearly seen in FIG. 2, which distinctly shows the sealing profile compressed at the reinforcing bars 9.

It may also be specified that the profile 18 may be adhesively bonded to the jamb 2.

Another important point to be emphasized concerning this sealing profile is that it may be made of an anti-abrasion material which helps sliding and thus does not damage the shutter.

Naturally, the invention is not limited to the embodiment described above by way of non-limiting example, but encompasses all embodiments thereof.

Thus, in the case of jambs made of extruded or pultruded plastic, it could be envisaged co-extruding or co-pultruding a sealing element which would thus form a single piece with the jamb.

1. A folding door comprising:
two vertical jambs, each of which contains a slide;
a winding shaft positioned at a top of the two jambs;
a flexible shutter with a lower bar connected to the winding shaft by means of at least one strap and at least one reinforcing bark,
wherein a width of the shutter is smaller than a distance separating inner faces of each of the jambs, wherein ends of at least one reinforcing bar are fitted and guided in slides provided in each of the jambs, it being possible for the shutter to assume a closed position in which it is deployed in a separation plane defined by the jambs and the winding shaft, or an open position in which the shutter is folded by winding each strap on the shaft and forming at least one fold on one side of the separation plane, and
wherein on a side of the shutter opposite that on which the folds are formed, at least one of the jambs comprises an elastic sealing means against which the shutter rests.

2. The door as claimed in claim 1, wherein at least one of the jambs has two flanges forming slides, a sealing profile being attached to the flange located on a side opposite that on which the folds are formed.

3. The door as claimed in claim 2, wherein the sealing profile has a rigid base designed to be pressed against one of the jambs and a flexible lip designed to rest against the shutter.

4. The door as claimed in claim 3, wherein the flexible lip has a cross section of spiral shape.

5. The door as claimed in claim 3, wherein the base has two substantially perpendicular plates bearing on two faces of a flange of a jamb.

6. The door as claimed in claim 1, wherein each reinforcing bar has, at each of its ends, a roller traveling between two flanges of the slide.

7. The door as claimed in claim 1, wherein at least one of the jambs has two flanges, the flange located on a side opposite that on which the folds are formed has an extension so as to form a bearing surface for the shutter, this extension being made by co-extrusion, co-molding or co-pultrusion of an elastic material.

8. The door as claimed in claim 7, wherein the extension has an elastically deformable geometry.

9. The door as claimed in one of claim 1, wherein the jambs containing the slides are vertical.

10. The door as claimed in claim 1, wherein the jambs containing the slides are oriented in a direction other than vertical.
